(19) United States
(12) Patent Application Publication
(10) Pub. No.: US 2004/0028315 A1
(43) Pub. Date: Feb. 12, 2004

(54) Electrooptical transmission module

(76) Inventor: Hans-Dieter Weigel, Caputh (DE)

Correspondence Address: LERNER AND GREENBERG, P.A., POST OFFICE BOX 2480, HOLLYWOOD, FL, 33022-2480, US

(21) Appl. No.: 10/632,759

(22) Filed: Aug. 1, 2003

(30) Foreign Application Priority Data
Aug. 2, 2002 (DE) 102 36 375.7

(51) Int. Cl. G02B 6/12

(52) U.S. Cl. 385/14

(57) ABSTRACT

An electrooptical transmission module includes an electrooptical transmitting and/or receiving device, a printed circuit board with at least one control module for the electrical driving of the transmitting and/or receiving device, and a base part. The base part serves for securing at least one of the components mentioned. At least two guiding elements are provided. The guiding elements are firmly connected to the base part and pass through the printed circuit board in the region of bores substantially without any play. This permits a configuration of the individual module components in relation to one another and with respect to a mounting board with only small positional tolerances.

### BACKGROUND OF THE INVENTION

### Field of the Invention

The invention relates to an electrooptical transmission module.

Electrooptical transmission modules, which include a number of module components to be adjusted in relation to one another, are known. FIG. 7 shows as an example of this: a transmission module produced by Infineon Technologies AG under the designation “PAROLI”. The transmission module 100 has an electrooptical transmitting or receiving device in the form of a surface-active transducer component including for example one or more vertical-emitting lasers (VCSEL). In electrical connection with the transducer component as an electronic drive device is a signal processing IC. The signal processing IC is electrically connected to a printed circuit board 104. Via the printed circuit board 104, electrical signals can be transmitted from the signal processing IC to a circuit board of a computer and vice versa.

The transmission module 100 has a heat sink 107, which cools the rear sides of the printed circuit board 104, of the transducer component and of the signal processing IC. The heat sink 107 has four mounting legs 171, 172, 173, 174, which respectively have a screw thread 175, so that the module 100 can be mechanically fixed securely on a mounting board by using a screw connection.

The transmission module also has a contacting device, which is formed by a plug half 106 with a multiplicity of contact pins 161. The plug half 106 is soldered to the printed circuit board 104 and mounted on its upper side. The associated second plug half is disposed on an assigned circuit board, so that the transmission module 100 can be coupled to a circuit board by using the two plug halves.

During the mounting of the module, the heat sink 107, the printed circuit board 104 and the contacting device 106 are to be positioned exactly in relation to one another. If the positional tolerances of the module components are too great, problems arise with respect to the internal module structure and also locational problems in the configuration of the module 100 on a mounting board. The required accuracies can be achieved only with great production expenditure.

A further problem is that the plug part connected to the mounting board can easily be misaligned during the soldering operation (for example reflow soldering), including in its angle. Together with the positional tolerances in the module itself, a tolerance chain may occur in the module itself, which leads to considerable slanting of the module 100 with respect to the mounting board. This has the effect that certain locationally determined coupling elements, such as for example backplane adapter systems, cannot be used. When there is slanting of the plug halves, this also causes stressing in the soldering and plugging system.

Alternative embodiments of a transmission module do not have a separate contacting device. The contact between the printed circuit board and the mounting board takes place for example by using a leadframe. The heat sink serving as a carrier part is inserted into receiving bores of an associated mounting board by using mounting legs. Problematical here is the provision of the internal module structure with the required tolerances with respect to the mounting legs. If this is unsuccessful, considerable problems can be expected when the module terminals are brought into electrical contact with the associated contact pads of the mounting board.

### SUMMARY OF THE INVENTION

It is accordingly an object of the invention to provide an electrooptical transmission module that overcomes the hereinafore-mentioned disadvantages of the heretofore-known devices of this general type and that has an optimized locational accuracy of all the components of the module and, in addition, a high locational accuracy with respect to the mounting board. At the same time, it is intended that the structure be simple and include only a few parts of a simple construction.

With the foregoing and other objects in view, there is provided, in accordance with the invention, an electrooptical transmission module. The electrooptical transmission module includes an electrooptical communication device, a printed circuit board, a base part, and at least two guiding elements. The printed circuit board has a control module electrically driving the electrooptical communication device and has bores formed therein and regions around the bores. The base part secures the electrooptical communication device and/or the printed circuit board. The guiding elements firmly connect to the base part and passing through the printed circuit board in the regions of the bores without any play.

In accordance with a further object of the invention, the term “electrooptical communication device” is meant to be a generic term referring to electrooptical transmitting and/or receiving devices. Examples of electrooptical communication devices include receivers, transmitters, and transceivers.

The configuration according to the invention is accordingly distinguished by the fact that at least two guiding elements firmly connected to a base part are provided. The elements reach through the printed circuit board (and if appropriate further module components) in the region of bores substantially without any play. The solution according to the invention is thereby based on the idea of providing two reference points, onto which the other components of the module can be strung. These reference points are provided by the two guiding elements. At least two guiding elements are used, in order also to allow rotational displacement of the individual components to be reliably prevented.

Unlike in the case of the prior art, the base part consequently provides structures that pass through the printed circuit board (and if appropriate further components) and prevent a relative movement in the lateral direction between the base part and the printed circuit board. The components are fixed in their position.

The use of guiding elements on the base part also serves for the optimum positioning of the module with respect to the mounting board. The guiding elements preferably are insertable into receiving bores in the mounting board.

In a preferred refinement, the transmission module additionally has a substantially flat-formed contacting device. The flat-formed contacting device is disposed parallel to the printed circuit board and serves for the electrical connection of the printed circuit board to a circuit board. The guiding elements passes through the contacting device in the region of bores—substantially, without any play. The contacting device is preferably a contact board that is electrically connected to the printed circuit board and has electrical via holes, to which contact pads on a circuit board are assigned. Consequently, the printed circuit board and the contact board are exactly fixed in their position in relation to the base part and also in their position in relation to each other.

The contacting device is advantageously mounted in the transmission module in a floating manner in a direction perpendicular to the printed circuit board. This makes it possible in particular to compensate for tolerances that are caused by slanting of the contacting device.

In a further preferred refinement, two guiding elements are provided in diagonal configuration in relation to each other. The diagonal alignment is advantageous in particular for so-called “belly to belly configurations”, in which two modules are mounted in a mutually facing position on two opposite sides of a mounting board.

The transmission module according to the invention preferably has a pressure-exerting device, which presses the base part, the printed circuit board, and if appropriate further components such as the contacting device, against one another in a direction perpendicular to the printed circuit board. As a result, slight play in the vertical direction (perpendicular to the printed circuit board) is avoided. However, the pressure-exerting device preferably allows a floating or resilient configuration at least of one component of the transmission module, which is achieved by the pressure-exerting device having a compression spring.

The pressure-exerting device is preferably formed by at least one spring-actuated screwing element, which is mounted in a bore of the base part and passes through the individual components.

In a preferred refinement, two spring-actuated screwing elements are disposed diagonally on the base part in such a way that, together with the two likewise diagonally disposed guiding elements, they form the corners of a rectangle.

The guiding elements are preferably guiding bolts pressed positionally exactly into the base part. They also preferably have an internal thread, which makes it possible to fasten the module firmly on the mounting board by using screws.

The base part is generally formed by a heat sink of the transmission module. The guiding elements in this case protrude from the side of the heat sink on which no cooling ribs or the like are located.

It is pointed out that, apart from the printed circuit board, further components of the module such as a contact board or else a leadframe are also preferably fixed by the guiding elements in their position in relation to the base part and in relation to one another.

Other features that are considered as characteristic for the invention are set forth in the appended claims.

Although the invention is illustrated and described herein as embodied in an electrooptical transmission module, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view showing an electrooptical transmission module according to the invention obliquely from above;

FIG. 2 is a perspective view showing the transmission module of FIG. 1 obliquely from below;

FIG. 3 is a perspective view showing a heat sink with two guiding bolts of the transmission module of FIGS. 1 and 2;

FIG. 4 is an exploded, perspective view of the electrooptical module;

FIG. 5 is a perspective view with two of the electrooptical modules according to FIGS. 1 to 4 in a “belly to belly configuration”;

FIG. 6 is a perspective view showing the individual module configuration of the transmission module of FIGS. 1 to 4 together with a counter-pressure-exerting plate; and

FIG. 7 is a perspective view showing an electrooptical transmission module according to the prior art.

### DESCRIPTION OF THE PREFERRED EMBODIMENTS

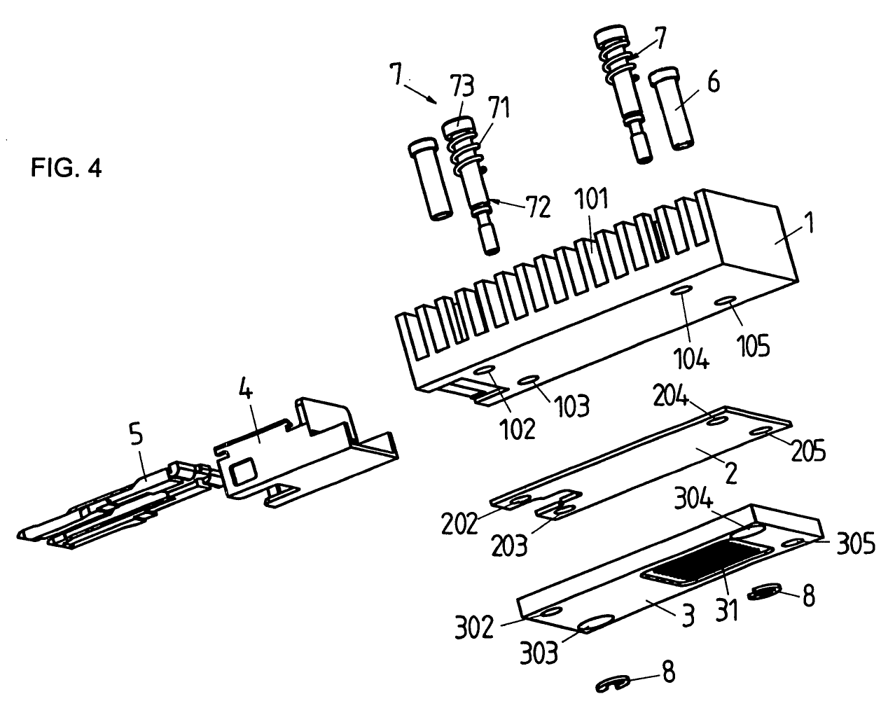

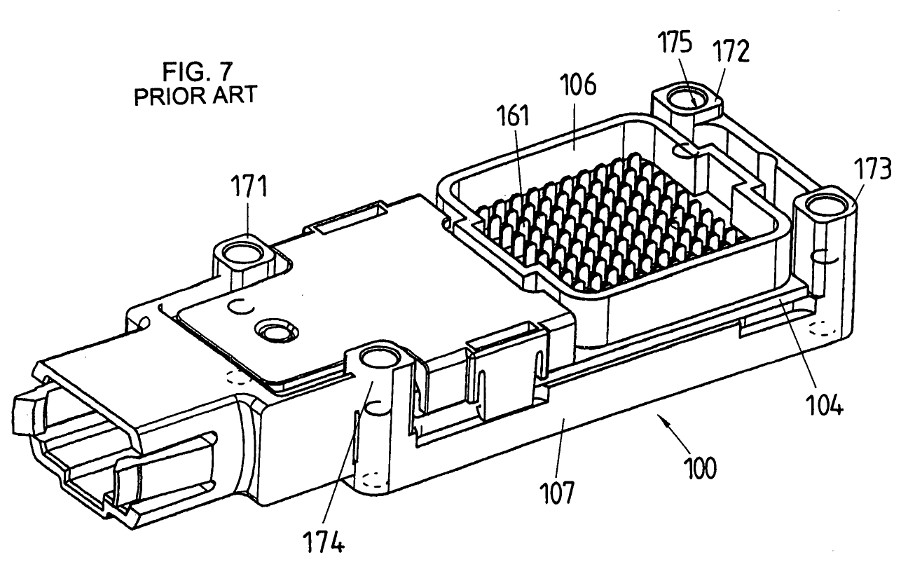

Referring now to the figures of the drawings in detail and first, particularly to FIG. 4 thereof, there are shown the individual components of an electrooptical transmission module in an exploded view. The electrooptical transmission module accordingly has a base part 1 formed by a heat sink, a printed circuit board 2, a contact board 3, and a coupling region 4 with a plug guide 5. As described on the basis of FIG. 7 and known per se, at least one electrooptical transmitting and/or receiving device, which is for example an array of VCSEL lasers, is disposed in the coupling region 4. For driving the transmitting and/or receiving device, at least one control module (not separately represented) is disposed on the printed circuit board 2.

The contact board 3 serves for the electrical connection of the printed circuit board 2 to a mounting board or a circuit board of a computer. The contact board 3 has for this purpose a contacting device 31, which is formed by a multiplicity of via holes. Associated contact pads are disposed on a mounting board. The contacting device conforms to customary standards and is formed for example as an MPI (metallized particle interconnect) system.

The heat sink 1 cools the rear sides of the printed circuit board 2, of the control module disposed on the printed circuit board and of the transmitting and/or receiving device. It has on its side facing away from the printed circuit board cooling ribs 101. The side facing the printed circuit board 2 is formed in a planar manner and runs parallel to the printed circuit board 2 and the contact board 3.

Formed in the heat sink 1 are four bores 102, 103, 104, 105, which serve for receiving two guiding bolts 6 and two screwing elements 7, which are for example set screws, serving as guiding and positioning elements. The guiding bolts 6 are pressed into two diagonally opposite bores 102, 105 of the heat sink 1, so that they are fixed firmly and positionally exactly on the heat sink 1. The guiding bolts 6 pass through both the printed circuit board 2, in bores 202, 205, and the contact board 3, in bores 302, 305. The guiding bolts 6 in this case pass through the corresponding bores of the printed circuit board 2 and of the contact board 3 without any play or substantially without any play, so that the printed circuit board 2 and the contact board 3 are positioned and fixed definitively with respect to the heat sink 1. The contact board 3 and the printed circuit board 2 are as it were strung onto the guiding bolts 6 pressed into the heat sink 1. This achieves the effect that the location of the internal module components 1, 2, 3 in relation to one another is fixed exactly.

In addition, the guiding bolts 6 also allow an exact positioning of the location of the module in relation to an assigned mounting board. The ends of the guiding bolts 6 thereby protrude with respect to the underside of the contact board 3, so that they can be inserted into assigned bores of a mounting board.

The screwing elements 7 are likewise diagonally disposed and pass through the further bores 103, 104 of the heat-sink base part 1, 203, 204 of the printed circuit board and 303, 304 of the mounting board 3. The screwing elements 7 respectively have under the screw head 73 a compression spring 71. At the same time, they have a peripheral groove 72, which serves for receiving a securing disc 8. The screwing elements 7 in this way hold the strung-on parts 1, 2, 3 together captively and floating slightly. Consequently, on account of the use of a compression spring 71, a gentle pressure is exerted on the individual components 1, 2, 3 and at the same time a certain displacement is possible in the axial direction of the screwing elements 7. This facilitates in particular the connection of the contact device 31 of the contact board 3 to the mounting board. In particular, it is possible by the floating mounting of the contact board 3 to compensate for slanting between the printed circuit board 2 and the mounting board.

On account of the exact fixing of the individual module components 1, 2, 3 in relation to one another, remaining tolerances of the transmission module can be caused only by positional tolerances of the individual components on one component, for example of the plug part 31 with respect to the bores 302, 305. The components 1, 2, 3 used have very small tolerances as a result of their production processes.

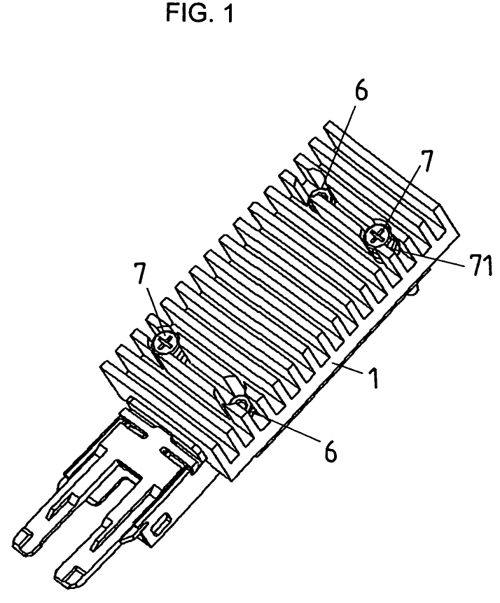

FIG. 1 then shows the transmission module in a perspective view from above. The guiding bolts 6 are pressed positionally exactly into the heat-sink base part 1. The screwing elements 7 are resiliently supported on the heat sink 1 by using the compression springs 71. The screwing elements 7 are preferably formed as cross-slotted screws, the screwing elements 7 additionally allowing secure fastening on a mounting board.

It is additionally provided in this case that the guiding bolts 6 are also formed as hollow cylinders and have an internal thread. The internal thread allows a further screw can be inserted. Accordingly, the transmission module can be fastened uniformly and securely on a mounting board by diagonal configuration of four fastening screws. In addition, positioning and fixing of the module during the production process can be performed by using the internal thread of the guiding bolts 6.

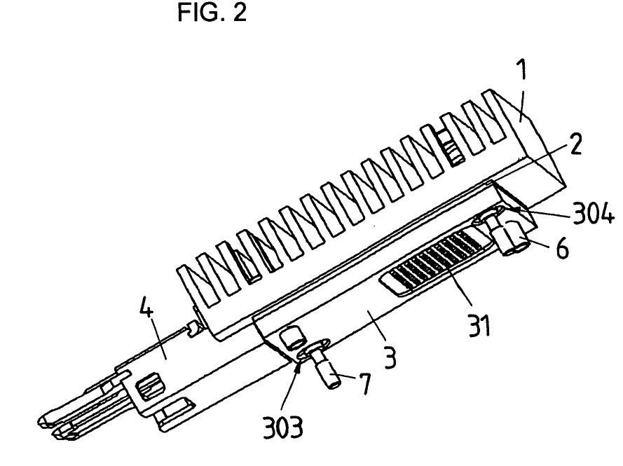

According to FIG. 2, the plug part 31 with the individual contact elements is disposed on the contact board 3. The contact board at the same time covers by its linear extension on one side the printed circuit board 2 with the discrete components mounted on it. As explained, disposed on the shanks of the screwing elements 7 reaching further through, within the contact board 3, are the securing discs 8, which hold the contact board 3 resiliently on the printed circuit board 2 and the heat sink 1 of the module. In this case, the bores 303, 304 of the contact board 3 are widened on the underside, in order to be able to receive the securing discs 8 which lie against the grooves 72 of the screwing elements 7.

The view of FIG. 2 further reveals that the ends of the guiding bolts 6 protrude beyond the contact board 3.

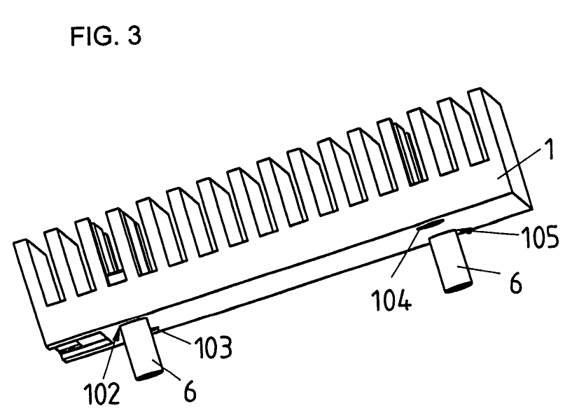

The view of FIG. 3 merely shows the heat sink 1 with the pressed-in guiding bolts 6 for the positioning of all the components of the transmission module. As already explained on the basis of FIG. 4, the heat sink has in this case four identical bores 102, 103, 104, 105, in which the two guiding bolts 6 are pressed in diagonally.

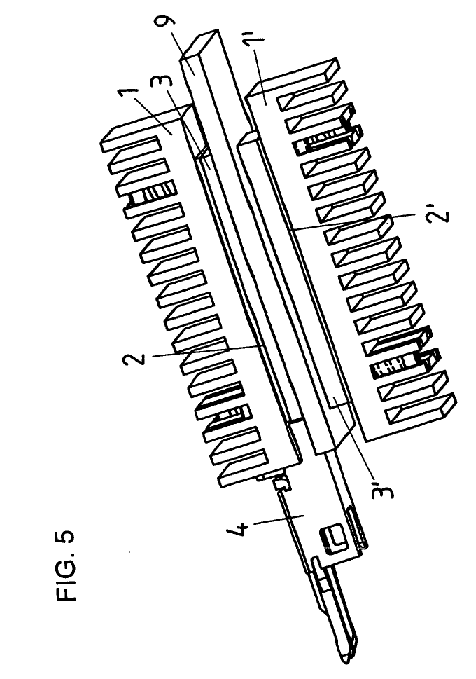

FIG. 5 shows a “belly to belly configuration” of two transmission modules. Disposed in this case between the two modules with heat sinks 1, 1′, printed circuit boards 2, 2′ and contact boards 3, 3′ is a mounting board 9. The guiding bolts protruding from the contact boards 3, 3′ serve for the positioning of the transmission module on the mounting board 9. The threads within the diagonally configured bushes serve for the mutual fastening of the modules in relation to one another. It is pointed out that in FIG. 5 the coupling region 4 is only represented on one module.

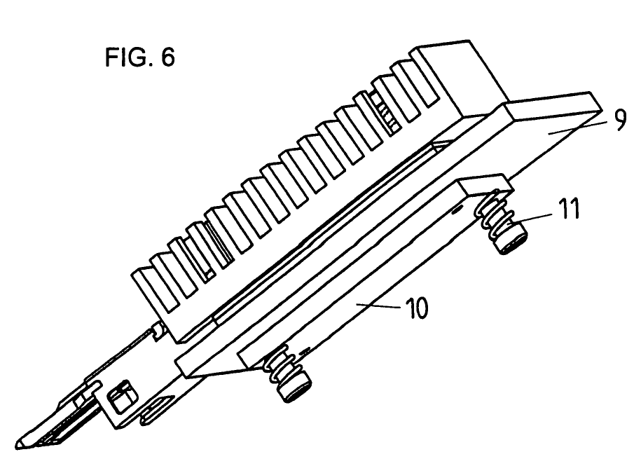

Finally, FIG. 6 shows an individual module configuration in which the module is positioned on a mounting board 9 by using a counter-pressure-exerting plate 10. The counter-pressure-exerting plate 10 is used to permit secure screwing of the module and prevent bending of the mounting board 9. At the locations of the screwing elements 7 of the module, a thread is respectively contained in the counter-pressure-exerting plate 10, so that the screwing elements can be securely screwed in the counter-pressure-exerting plate 10. At the two other diagonal points, a shoulder screw 11, in each case with a compression spring and a securing disc, is captively disposed in sunken bores, so that the counter-pressure-exerting plate 10 is firmly connected to the mounting board 9.

I claim:

1. An electrooptical transmission module, comprising:
an electrooptical communication device;
a printed circuit board with a control module electrically driving said electrooptical communication device and having bores formed therein and regions around said bores;
a base part securing at least one of said electrooptical communication device and said printed circuit board; and
at least two guiding elements firmly connected to said base part and passing through said printed circuit board in said regions of said bores without any play.

2. The module according to claim 1, further comprising a substantially flat-formed contacting device having bores formed therein and regions about said bores, and being disposed parallel to said printed circuit board and configured to electrically connect said printed circuit board to a circuit board, said guiding elements passing through said contacting device in said region of said bores without any play.

3. The module according to claim 2, wherein the circuit board has a transmission module mounted thereon.

4. The module according to claim 2, wherein said contacting device is a contact board electrically connected to said printed circuit board and having a contact element on a first side, a second side being formed by pads of the circuit board.

5. The module according to claim 4, wherein said contacting device is mounted in a floating manner and in a direction perpendicular to said printed circuit board.

6. The module according to claim 1, wherein said two guiding elements are provided in a diagonal configuration relative to each other.

7. The module according to claim 1, further comprising a pressure-exerting device pressing said base part and said printed circuit board against one another in a direction perpendicular to said printed circuit board.

8. The module according to claim 7, wherein:
said base part has a bore; and
said pressure-exerting device is formed by a spring-actuated screwing element mounted in said bore of said base part and passes through said base part and said printed circuit board.

9. The module according to claim 6, further comprising two spring-actuated screwing elements disposed diagonally on said base part, said screwing elements and said guiding elements defining corners of a rectangle.

10. The module according to claim 8, further comprising two spring-actuated screwing elements disposed diagonally on said base part, said screwing elements and said guiding elements defining corners of a rectangle.

11. The module according to claim 1, wherein said guiding elements are guiding bolts pressed positionally exactly into said base part.

12. The module according to claim 1, wherein said base part is a heat sink.

13. The module according to claim 1, wherein said guiding elements protrude to allow said guiding elements to be inserted into assigned bores of a mounting board.

14. The module according to claim 1, wherein said guiding elements have an internal thread.

15. The module according to claim 1, further comprising a further module component fixed by said guiding elements relative to said base part.

16. The module according to claim 1, wherein said electrooptical communication device is a transmitter.

17. The module according to claim 1, wherein said electrooptical communication device is a receiver.

18. The module according to claim 1, wherein said electrooptical communication device is a transceiver.

19. The module according to claim 1, further comprising:
a circuit board; and
a substantially flat-formed contacting device having bores formed therein and regions about said bores, and being disposed parallel to said printed circuit board and electrically connecting said printed circuit board to said circuit board, said guiding elements passing through said contacting device in said region of said bores without any play.

20. The module according to claim 19, further comprising a pressure-exerting device pressing said base part and said printed circuit board, and said contacting device, against one another in a direction perpendicular to said printed circuit board.

21. The module according to claim 20, wherein:
said base part has a bore; and
said pressure-exerting device is formed by a spring-actuated screwing element mounted in said bore of said base part and passes through said base part, said printed circuit board, and said contacting device.

22. The module according to claim 21, further comprising two spring-actuated screwing elements disposed diagonally on said base part, said screwing elements and said guiding elements defining corners of a rectangle.
